(19) United States
(12) Patent Application Publication
(10) Pub. No.: US 2015/0063911 A1
(43) Pub. Date: Mar. 5, 2015

(54) Method and System for Oil Release Management with Booms

(71) Applicant: EXXONMOBIL UPSTREAM RESEARCH COMPANY, Houston, TX (US)

(72) Inventor: Timothy J. Nedwed, Houston, TX (US)

(21) Appl. No.: 14/385,472

(22) PCT Filed: Mar. 19, 2013
(86) PCT No.: PCT/US2013/032995

§ 371 Date: Sep. 15, 2014

Related U.S. Application Data
(60) Provisional application No. 61/638,166, filed on Apr. 25, 2012.

(51) Int. Cl. E02B 15/06; G05D 7/06

(52) U.S. Cl. CPC E02B 15/06; G05D 7/0676
USPC 405/63

(57) ABSTRACT

In one embodiment, a method for managing a hydrocarbon (e.g., oil) release with one or more booms is described. The method comprises: deploying one or more booms to a location in a body of water, wherein each of the booms has a floating section that is partially disposed in the body of water and extends out of the body of water, a skirt and ballast section beneath the floating section, and an anchor section that secures the boom at a relatively fixed location, wherein at least one of the one or more booms has a boom monitoring section that includes a measurement component.

### CROSS-REFERENCE TO RELATED APPLICATION

This application claims the benefit of U.S. Provisional Patent Application 61/638,166, filed Apr. 25, 2012, entitled METHOD AND SYSTEM FOR OIL RELEASE MANAGEMENT WITH BOOMS, the entirety of which is incorporated by reference herein.

### FIELD OF THE INVENTION

This invention relates generally to the field of hydrocarbon operations. Specifically, the invention relates to operations for managing oil releases.

### BACKGROUND OF THE INVENTION

In the oil and gas industry, hydrocarbons are accessed via a wellbore to provide a fluid flow path to a processing facility. Some of these hydrocarbon resources are located under bodies of water, such as lakes, seas, bays, rivers and/or oceans, while others are located at onshore locations. To transfer hydrocarbons from such locations, a pipeline and/or one or more different vessels (e.g., ship or tanker trucks) may be utilized through various segments from the wellbore and the processing facility.

Additionally, hydrocarbons may be transported from a production region to another region for consumption/processing into hydrocarbon-based products or from one hydrocarbon storage location to another. Transfer of hydrocarbons between such locations often requires one or more different vessels and routes over bodies of water, such as lakes, seas, bays, rivers and/or oceans.

Offshore leaks and/or spills from transfer operations may be problematic due to the hydrocarbons being released into a body of water. Typically, the hydrocarbons may form a slick on the surface of the water, which may be referred to as an oil slick. Response to these oil slicks is often facilitated by the deployment of booms to either contain the slick or divert it away from one or more areas.

Booms are sometimes used to protect sensitive shorelines by either containing or diverting the oil from the shoreline. These booms are placed near an area to be protected and anchored at both ends to secure at a specific location. In some instances, multiple booms may be connected together to further manage the oil slick. A boom typically consists of a floating section that has a portion partially submerged in the water and a portion that extends out of the water, a skirt and ballast section that is located under the water, and an anchor section utilized to secure the boom in a relatively fixed location.

While these booms are useful to divert oil, one problem with booms is that they are placed in remote areas and require manual inspection to determine whether the integrity of the boom is being maintained. That is, manual inspection is utilized to determine whether one or more boom operation events have occurred (e.g., anchors failed or whether the integrity of the boom has been compromised). Further, manual inspection may be used to determine whether the boom is being inundated or contacted by hydrocarbons, as another type of boom operation event. Because the oil slick may cover a wide area, many different boom systems may be deployed. As a result, the manual inspections are not constant and booms can either fail or be inundated by hydrocarbons for a significant time before a subsequent inspection. If the boom fails, it is no longer protecting the intended shoreline segment and there is potential for hydrocarbons to reach the shorelines. If a boom is being inundated with hydrocarbons, operation personnel should skim or remove the hydrocarbons from the water near the boom and the boom itself Delays in hydrocarbon removal increase the likelihood that hydrocarbons may entrain over or under the boom and impact the shoreline segment being protected.

As the management of hydrocarbon leaks and spills is a time consuming operation, a need exists to enhance operations to manage hydrocarbon releases with enhanced methods and systems. In particular, a need exists to automatically sense boom failure and/or automatically sense hydrocarbons contacting the boom. The enhanced boom may communicate a signal to a central location to notify the appropriate operations personnel of its condition. In this manner, booms more effectively protect shorelines and sensitive areas from released hydrocarbons in bodies of water, such as marine and fresh water.

Other related documents include U.S. Pat. Nos. 7,056,059 and 7,785,036.

### SUMMARY OF THE INVENTION

In one embodiment, a method for managing a hydrocarbon (e.g., oil) release with one or more booms is described. The method comprises: deploying one or more booms to a location in a body of water, wherein each of the booms has a floating section that is partially disposed in the body of water and extends out of the body of water, a skirt and ballast section beneath the floating section, and an anchor section that secures the boom at a relatively fixed location, wherein at least one of the one or more booms has a boom monitoring section that includes a measurement component and a communication component; measuring data associated with the operation of at least one of the one or more booms with the measurement component; and transmitting a signal associated with the data to a command unit via the communication component.

In one or more embodiments, a boom monitoring system is described. The system comprises a command unit; and a boom in communication with the command unit.

The boom includes a floating section that is partially disposed in the body of water and extends out of the body of water; a skirt and ballast section beneath the floating section and an anchor section that secures the boom at a relatively fixed location; and a boom monitoring section that includes a measurement component and a communication component; wherein the measurement component measures data associated with the operation of the boom; and the communications component transmits a signal associated with the data to the command unit. The skirt and ballast section is configured to maintain proper boom orientation relative to the water surface. Further, the boom may also include a power component that is configured to provide power to one or more of the measurement component and the communication component. The power component may include a battery and equipment configured to utilize one or more wind, waves, and/or solar to generate power for the boom.

In other embodiments, various components may be utilizes. For example, the communication component may be configured to transmit to the command unit via one or more of wireless communication hardware and satellite communication hardware. The measurement component may comprise a global positioning system (GPS) module and sensors that are configured to monitor the location of the boom, and a hydrocarbon sensing module and sensors that are configured to monitor the floatation section for contact with hydrocarbons, wherein the hydrocarbon sensing module and sensors measure the electrical resistance at various locations along the length of the floating section. The measurement component may also include a pressure module and sensors that are configured to measure pressure along the floating section, and/or an air pressure module and sensors that are configured to monitor the pressure within the flotation section. Further still, the measurement component may also include a boom integrity module and sensors configured to determine if the flotation section is damaged.

### BRIEF DESCRIPTION OF THE DRAWINGS

The foregoing and other advantages of the present disclosure may become apparent upon reviewing the following detailed description and drawings of non-limiting examples of embodiments.

FIG. 1 is a diagram of an autonomous boom system in accordance with an exemplary embodiment of the present techniques.

FIG. 2 is a diagram of a boom monitoring section in accordance with an to exemplary embodiment of the present techniques.

FIG. 3 is a flow chart for implementing an autonomous boom system in accordance with an exemplary embodiment of the present techniques.

### DETAILED DESCRIPTION OF THE PREFERRED EMBODIMENTS

In the following detailed description section, the specific embodiments of the present disclosure are described in connection with preferred embodiments. However, to the extent that the following description is specific to a particular embodiment or a particular use of the present disclosure, this is intended to be for exemplary purposes only and simply provides a description of the exemplary embodiments. Accordingly, the disclosure is not limited to the specific embodiments described below, but rather, it includes all alternatives, modifications, and equivalents falling within the true spirit and scope of the appended claims.

Various terms as used herein are defined below. To the extent a term used in a claim is not defined below, it should be given the broadest definition persons in the pertinent art have given that term as reflected in at least one printed publication or issued patent.

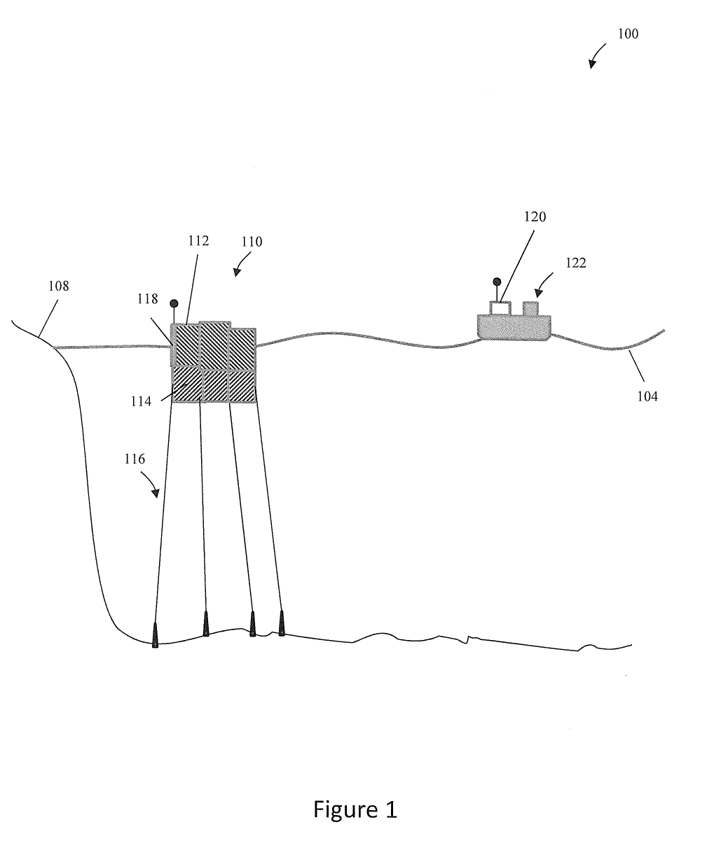

The present disclosure describes an oil spill boom that includes an autonomous boom monitoring system and method. With this autonomous boom monitoring system, one or more booms may include measurement components, communication components and/or location components to enhance operation of the system. The system and method include one or more booms that use sensors to monitor its integrity (e.g., anchor failure, boom splitting/failure, or boom sinking). In addition, the system may include one or more booms that are equipped with sensors that may determine if one of the portions of the boom is being contacted by floating oil. If any of these boom operation events occur, the one or more of the booms may send a communication to a command unit, which may be an oil spill response incident command center, alerting one or more response teams of the situation. Personnel from the response team can then be deployed to repair and/or replace the boom or recover oil that is contacting the boom. This will ensure that oil is collected as soon after the boom is contacted by oil or the boom is repaired/replaced as soon as possible after it fails. Various aspects of the present techniques are described further in FIGS. 1 to 3.

FIG. 1 is a diagram of an autonomous boom monitoring system 100 in accordance with an exemplary embodiment of the present techniques. A boom monitoring system 100 may include one or more booms, such as boom 110, that are in communication with a command unit 120, which is shown disposed on a ship 122. The booms and the ship 122 may be disposed in a body of water 104 and the booms may be deployed to protect a sensitive area of shore 108.

Booms may be connected together to manage the hydrocarbons floating on the surface of the body of water 104. For example, boom 110 may include a floating section 112 that has a portion partially submerged in the water 104 and a portion that extends out of the water 104, a skirt and ballast section 114 that is located in the water 104, and an anchor section 116 utilized to secure the boom in a relatively fixed location. The floating section 112 is designed to maintain hydrocarbons from entraining over the boom, and the skirt and ballast section 114 is designed to maintain hydrocarbons from entraining under the boom. Combined the floating section 112 and the skirt and ballast section 114 are utilized to either contain or divert the hydrocarbons to protect the shore 108. The anchor section 116 may include one or more anchors and associated lines to secure the anchors to the skirt and ballast section 114. If more than one boom is used, each boom 110 may include these different sections 112, 114 and 116.

Further, the boom 110 may include a boom monitoring section 118 that is utilized to determine whether a boom operation event has occurred. The boom monitoring section 118 may include power components, communication components and/or measurement components. Each of these components may be located within a secure compartment to minimize exposure to water or other environmental conditions. Further, if more than one boom is used, the boom monitoring section 118 may be installed in one boom or may be installed in two or more of the booms, depending on the specific configuration and redundancy considerations. Further, the boom monitoring section 118 may include a portion of the components integrated with the floating section 112, while another portion of the components may be disposed into a tethered floatation vessel or vessels that is able to maintain these components separate from the boom.

The power components may include a battery, wind, wave, and/or solar powered equipment. The different components or modules may be powered from the power component or may include separate power sources for each of the respective components or modules. Also, the different components and modules may also utilize a separate power source as a redundant power supply in certain embodiments.

The communication components may include communication equipment that is utilized with one or more antennas to communicate with one or more of other booms, internal components or modules, and/or the command unit 120. The communication equipment may utilize technologies, such as radio, cellular, wireless, microwave or satellite communication hardware and software. Also, the communication equipment may include and utilize any of a variety of known protocols to manage the exchange of information (e.g., Ethernet, TCP/IP, and the like). The communication equipment utilized may depend on the specific deployment locations and configuration. For example, if two or more booms are located in close proximate to each other, one boom may include satellite communication equipment along with radio or wireless communication equipment, while the other booms may include only radio or wireless communication equipment. In this manner, the boom with the satellite communication equipment may handle communication to the command unit 120 for the other booms. Alternately, each boom may include each of measurement components and/or modules and communication components to operate independently.

The measurement components may include various modules that provide information relating to boom operation events. For example, the measurement components may include a global positioning system (GPS) module and sensors that monitor boom location over time; a hydrocarbon sensing module and sensors that monitor for boom contact with hydrocarbons present near or on the surface of the water (e.g., a system that monitors electrical resistance along the length of the boom and alarms when the resistance changes because of contact by oil); a pressure module and sensors that alarm if the boom sinks below the surface of the water; an air pressure module and sensors that alarm if the air-pressure inside and inflatable boom is decreasing, and/or boom integrity module and sensors to determine if the boom surface is damaged. The boom integrity module and sensors and the hydrocarbon module and sensors may be utilized as separate modules in communication with separate or shared sensors and/or a common module and sensor configuration. Regardless, the module or modules may identify boom splits as the sensors may detect that the electrical resistance along the length of the boom becomes infinite for an integrity boom operation event, while the presence of hydrocarbons may be determined by a change in the electrical resistance.

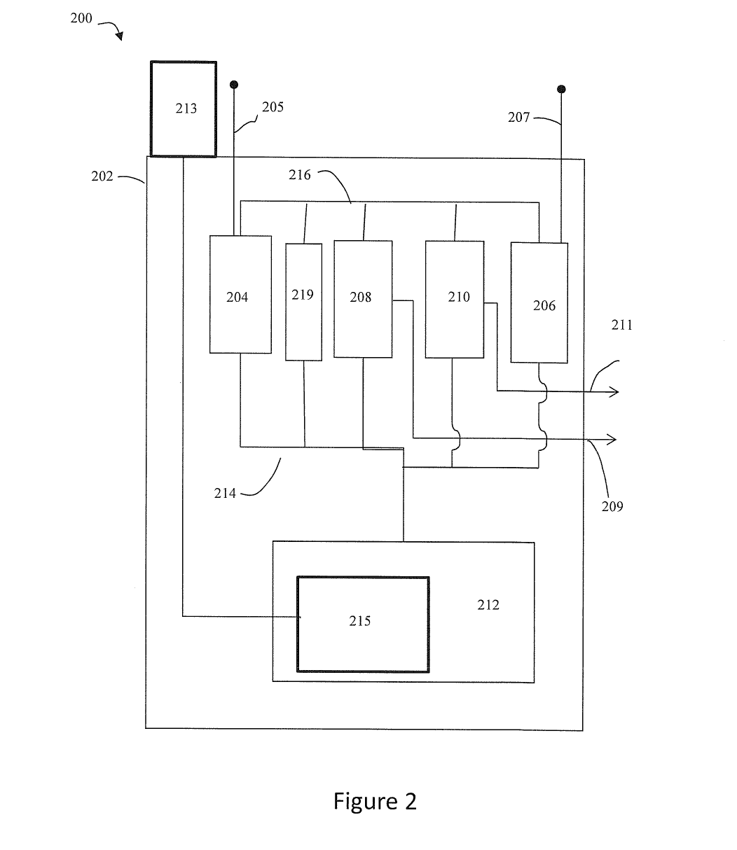

FIG. 2 is an exemplary boom monitoring section 200, which may be one embodiment of the boom monitoring section 118 of FIG. 1. In this FIG. 2, the exemplary boom monitoring section 200 includes a housing 202 (e.g., a sealed housing that protects the measurement and communication modules from the elements) that encloses a global positioning system (GPS) module 204 and associated GPS antenna 205, a communication component 206 and associated communication antenna 207, a pressure module 208, a hydrocarbon sensing and integrity module 210 and a power component 212. The modules and components are provided power from the power component 212 via power distribution lines 214. Similarly, the different modules and components may communicate with each other via communication lines 216. This embodiment utilizes a central power and communication lines to manage the operation in an efficient manner.

To operate, the power component 212 may be utilized to supply power to the system (GPS) module 204, communication component 206, pressure module 208 and hydrocarbon sensing and integrity module 210. In this embodiment, the power component 212 includes a solar module 213 and batteries 215. The batteries 215 may provide power via the power distribution lines 214, which may include one or more cables, as an example. The solar module may include solar panels and associated equipment that are utilized to convert solar rays into power, which may be used to power the modules and components and also to recharge the batteries 215.

For communication, the communication component 206 is utilized to exchange information between the different modules and components and/or the command unit via the communication lines 216 and the communication antenna 207. The communication component 206 may utilize the communication lines 216 to handle the exchange of information, such as measured data, status indications or other notifications, between the modules, such as the GPS module 204, pressure module 208 and hydrocarbon sensing and integrity module 210. The communication line 216 may include a bus, Ethernet cable, fiber optics or other suitable physical connection. In an alternative embodiment, the communication between modules may be via a wireless connection. Similarly, the communication protocol may be any protocol known to those skilled in the art.

To monitor for boom operation events, the GPS module 204, the pressure module 208, the air-pressure module 219, and hydrocarbon sensing and integrity module 210 may be utilized to measure parameters. For example, the GPS module 204 may be utilized to determine whether the current boom location has changed above a certain threshold relative to the initial boom location. That is, the current boom location at a second time period may be compared to the initial boom location at a first time period. The amount of change in the boom location may indicate that the boom has broken free of the anchor section or that the anchors are not secured to the seafloor. As an example of the location monitoring operation, the antenna 205 detects signals that are provided to the of the GPS module 204. The signals associated with positioning information allow the GPS module 204 to determine the specific location of the boom at a second period of time (e.g., the current boom location). Then, the GPS module 204 may determine if the boom location has changed within a predetermined movement threshold relative to the initial boom location at a first period of time. This movement threshold may be associated with a specific linear distance to allow for different currents and wave action. For instance, the movement threshold may be less than 25 feet, 50 feet or even 75 feet. This movement threshold may be adjusted based on the GPS modules spatial sensitivity and/or the length of the lines utilized to secure the boom. In alternative embodiments, the GPS module 204 may provide the updated boom location to the communication component 206 or to a command unit via the communication component 206 to perform this determination.

As another example, the pressure module 208 may be utilized to determine the flotation status of the boom (e.g., if the current boom flotation status has changed relative to a certain floatation threshold or to the initial boom flotation status). That is, the current boom flotation status at a second time period may be compared to the initial boom flotation status at a first time period. The amount of change in the boom flotation status may indicate (i) that the boom has broken free of the skirt and ballast section if the boom floatation status indicates that the floatation section is higher than the initial flotation status or (ii) that the boom is sinking if the boom flotation status indicates that the flotation section is lower than the initial flotation status. As a particular example of the flotation monitoring, the flotation sensors (not shown) may detect pressure and provide an indication of the pressure at respective locations along the floating section, which may be the floating section 112 as shown in FIG. 1. The pressure indication (e.g., measured pressure or indication of the measured pressure) may be transmitted via a flotation line 209 to the pressure module 208. These pressure indications may be collected by the pressure module 208 and the pressure module 208 may determine the specific flotation status of the boom at a second period of m time (e.g., the current boom flotation status). Then, the pressure module 208 may determine if the boom flotation status has changed within a predetermined flotation threshold relative to the initial boom flotation status at a first period of time. This flotation threshold may be associated with a depth of the flotation section to allow for different wave movement or action. The flotation threshold may include the distance from the initial boom flotation water level to the top of the flotation section, to within two feet from the top of the flotation section or to within four feet from the top of the flotation section. This flotation threshold may be adjusted based on the length of the flotation section, the estimated wave action or other suitable factors. In alternative embodiments, the pressure module 208 may provide the updated boom flotation status to the communication component 206 or to a command unit via the communication component 206 to perform this determination.

Another example, the air-pressure monitoring and sensing module 219 may be utilized to determine the pressure of air within the floating section. Certain boom types utilize a floating section that is inflated prior to boom deployment. This allows the boom to occupy much less space when in storage. The air pressure within the floating section has to be maintained for the boom to float and operate efficiently. The air-pressure module 219 can operate with the pressure module 208 or as an alternative to it depending on the boom design. The air-pressure module 219 may determine if the air-pressure within the flotation section has changed within a predetermined pressure threshold relative to the initial flotation section pressure. In alternative embodiments, the air-pressure module 219 may provide the updated boom air-pressure status to the communications component 206 or to a command unit via the communication component 206 to perform this determination.

As yet another example, the hydrocarbon sensing and integrity module 210 may be utilized to determine the presence of hydrocarbons and/or whether the integrity of the boom is intact. That is, the current hydrocarbon presence status at a second time period and/or current integrity status at a second time period may be compared to a hydrocarbon threshold and an integrity threshold, respectively. These thresholds may be determined from set amounts or measured at a first period of time. The amount of change in the hydrocarbon presence status may indicate that hydrocarbons are contacting the boom, while the amount of change in the integrity threshold may indicate that the boom has been damaged or separated into two or more sections. As a particular example of the hydrocarbon sensing and integrity monitoring, the hydrocarbon sensing sensors (not shown) may detect electrical resistance and provide an indication of the electrical resistance along respective lengths of the boom (e.g., the floating section, which may be the floating section 112 as shown in FIG. 1). The electrical resistance indication (e.g., measured resistance or indication of the measured resistance) may be transmitted via a hydrocarbon sensing line 211 to the hydrocarbon sensing and integrity module 210. These resistance indications may be collected by the hydrocarbon sensing and integrity module 210 and the hydrocarbon sensing and integrity module 210 may determine the specific status of the boom. The status may include resistance changes because of contact by oil or the resistance becoming infinite if the boom splits. The hydrocarbon sensing and integrity module 210 may determine whether the resistance status has changed within a predetermined resistance threshold relative to the initial boom resistance status at a first period of time or to be within a predetermined range that indicates hydrocarbons are present. The hydrocarbon sensors may include multiple different segments to provide coverage for the boom. In alternative embodiments, the hydrocarbon sensing and integrity module 210 may provide the updated resistance status to the communication component 206 or to a command unit via the communication component 206 to perform this determination.

Referring back to FIG. 1, the command unit 120 may be utilized as a central location to manage the one or more booms disposed in different geographic areas. The command unit 120 may include power components, communication components and/or management components. The location of the command unit 120 is not dependent on the boom locations. Accordingly, the command unit 120 may be disposed on a vessel, such as ship 122, to facilitate timely response to any boom events. However, other embodiments may include the command unit 120 being located at an onshore location, on a platform, or even in a helicopter or plane.

Similar to the boom monitoring section 118, the power components may include a battery, wind, wave, and/or solar powered equipment. Further, the power components for the command unit 120 may also include turbines and/or engines. That is, the command unit 120 may be disposed on a vessel, such as ship 122, which may include motors that supply power to equipment on the ship 122.

The communication components may include communication equipment that is utilized with one or more antenna to communicate with one or more of other booms and other operation centers. The communication equipment may utilize technologies, such as radio, cellular, wireless, microwave or satellite communication hardware and software. Also, the m communications may utilize Ethernet communications, such as local area networks or wide area networks.

The management components may include different modules, which may include hardware, sets of instructions stored in memory and configured to be accessed by a processor to execute the set of instructions, or a combination of both. These modules may include a global positioning system (GPS) module that monitors the location of the respective booms, hydrocarbon sensing modules that monitor the any contact with booms, pressure sensing module that manages the surface of the water relative to the top of the boom; an air-pressure sensing module to monitor the pressure of inflatable floating sections; and/or a boom integrity module to determine if the boom segments are in communication with each other or within a remain. The boom integrity sensors and the hydrocarbon sensors may be utilized as separate modules or a common module to identify boom splits as the electrical resistance along the length of the boom becomes infinite.

Persons skilled in the technical field will readily recognize that in practical applications of the disclosed methodology, it is partially performed on a computer, typically a suitably programmed digital computer. Further, some portions of the detailed descriptions which follow are presented in terms of procedures, steps, logic blocks, processing and other symbolic representations of operations on data bits within a computer memory. These descriptions and representations are the means used by those skilled in the data processing arts to most effectively convey the substance of their work to others skilled in the art. In the present application, a procedure, step, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “processing” or “computing”, “calculating”, “comparing”, “determining”, “displaying”, “copying,” “producing,” “storing,” “adding,” “applying,” “executing,” “maintaining,” “updating,” “creating,” “constructing” “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer (e.g., one or more sets of instructions). Such a computer program may be stored in a computer readable medium. A computer-readable medium includes any mechanism for storing or transmitting information in a form readable by a machine (e.g., a computer). For example, but not limited to, a computer-readable (e.g., machine-readable) medium includes a machine (e.g., a computer) readable storage medium (e.g., read only memory (“ROM”), random access memory (“RAM”), magnetic disk storage media, optical storage media, flash memory devices, etc.), and a machine (e.g., computer) readable transmission medium (electrical, optical, acoustical or other form of propagated signals (e.g., carrier waves, infrared signals, digital signals, etc.)).

Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific operating system or environment.

Further, one or more embodiments may include methods that are performed by executing one or more sets of instructions to perform modeling enhancements in various stages. For example, the method may include executing one or more sets of instructions to perform comparisons between thresholds current statuses or indications along with transmitting data between modules, components and/or sensors.

As an example, a computer system may be utilized and configured to implement on or more of the present aspects. The computer system may include a processor; memory in communication with the processor; and a set of instructions stored on the memory and accessible by the processor, wherein the set of instructions, when executed, are configured to: receive a transmitted signal from the boom; determine whether the transmitted signal indicates that a boom operation event has occurred; provide one or more of a visual indication and audible notification associated with the boom operation event, if a boom operation event has occurred; and store the updated status in memory if a boom operation event has not occurred. Further, the determination of whether the transmitted signal indicates that the boom operation event has occurred may include a set of instructions, when executed, configured to: compare current boom location to an initial boom location; and compare the difference between the locations with a threshold; if the difference greater than the threshold, then indicate that a boom operation event has occurred; and if the difference is less than or equal to the threshold, then indicate that a boom operation event has not occurred. These initial locations may be stored in memory or transmitted from the boom. Also, the determination of whether the transmitted signal indicates that the boom operation event has occurred may include a set of instructions, when executed, configured to: compare the measured resistance to a resistance range; and if the measured resistance is within the resistance range, then indicate that a boom operation event has occurred; and if the measured resistance is outside the resistance range, then indicate that a boom operation event has not occurred. The resistance range may be a predetermined range for hydrocarbons resistance, and/or may include a range that indicates that the circuit has been disconnected (e.g., indicating that the skirt section has been damaged. Further still, the determination of whether the transmitted signal indicates that the boom operation event has occurred may include a set of instructions, when executed, configured to: compare the measured pressure to a pressure range of hydrocarbon resistance; and if the measured pressure is within the pressure range, then indicate that a boom operation event has occurred; and if the measured pressure is outside the pressure range, then indicate that a boom operation event has not occurred. The pressure range may be the preferred operational pressure range for the flotation section and/or the pressure range may indicate that water is present at the sensor location.

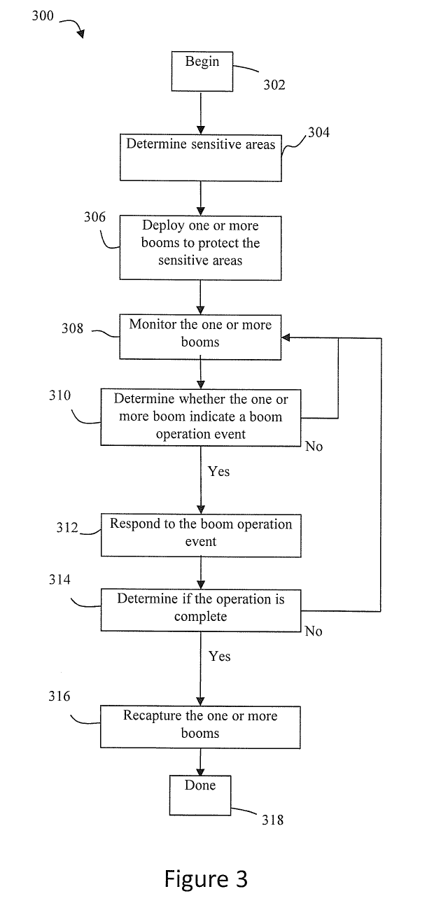

FIG. 3 is a flow chart 300 for implementing autonomous boom monitoring system in accordance with an exemplary embodiment of the present techniques. As noted above, this flow chart 300 includes a preparation and deployment stage, which includes blocks 302, 304 and 306, followed by a monitoring and operation stage, which includes blocks 308, 310, 312 and 314, and followed by a recovery stage, which includes blocks 316 and 318.

The process begins with the preparation and deployment stage, which determines the locations to be protected and deploying the booms at those locations. The process begins at block 302. Then, at block 304, the sensitive areas are determined The determination of the sensitive areas may include specific sections of shore line, shallow formations and/or other suitable locations. The determination may also include designing the geometry and layout plans for one or more booms for the sensitive areas. This determination may include selecting communication configurations based on the configuration of booms to manage the communication exchange between the modules and components that are part of the booms and/or the command unit. Also, the determination may include selecting the boom operation events to be monitored for the respective booms. Once the sensitive areas are identified, one or more booms are deployed to protect the sensitive areas, as shown in block 306. The deployment of the booms may include programming the booms to be able to communication within the modules and components of the boom, between modules and components of different booms and between modules and components and the command unit. The deployment may also include transporting the booms to the respective locations, placing one or more of the booms into the body of water, moving the one or more booms into the desired location, securing the one or more booms at the desired location, and verifying the communication between the command unit with one or more of the components and/or modules associated with at least one of the booms.

After the preparation and deployment stage, the monitoring and operation stage is performed, as noted in blocks 308, 310, 312 and 314. In block 308, the one or more booms may be monitored. The monitoring may include obtaining information (e.g., measurement data, status indicators or other signals that represent a boom operation event). The one or more booms may be configured to transmit information within a set time window (e.g., every 10 seconds, 60 seconds, 5 minutes, or even 10 minutes), transmit information when polled by the command unit, or transmit information when a boom operation event occurs (e.g., the different modules indicate that the respective status has changed enough to indicate a boom operation event has occurred). Then, at block 310, a determination is made whether the one or more booms indicate a boom operation event. This determination may be made by receiving information from the one or more booms and analyzing the information, as indicated above. This determination may be performed by the command unit executing a set of instructions on a computer system and providing an indication of the boom operation event to an operator via a display and/or an audible signal. If no boom operation event has occurred, then the process may continue to monitor the one or more booms, as shown in block 308. However, if a boom operation event has occurred, a response team may respond to the boom operation event, as shown in block 312. The response team may include a ship and personnel that are prepared to address the boom operation event. This response team may be located in the same ship as the command unit or may be in communication with the operator interacting with the command unit. The response team may include equipment necessary to repair/replace the boom, repair/replace anchors, repair/replace measurement and communication modules, and/or recover oil impacting the boom. In certain situations, the response team may not be deployed for a boom operation event. Regardless, a determination is made whether the operation is complete, as shown in block 314. If the operation is not complete, the one or more booms are continued to be monitored in block 308.

However, if the operations are complete, then the recovery stage may be performed in blocks 316 and 318. At block 316, the one or more booms are recaptured. The recapturing of the booms may include deploying a ship to the one or more boom locations, unsecuring the respective booms, recovering the booms to the ship, and/or recovering the anchors to the ship, transporting the one or more booms from the sensitive area. Further, this recapturing operation may also include transporting the booms to a storage location. Then, at block 318, the process is complete.

The present techniques may be implemented in various embodiments. For example, one or more embodiments are described below in the following paragraphs.
1. A method for managing an oil release with one or more booms, comprising:
   deploying one or more booms to a location in a body of water, wherein each of the booms has a floating section that is partially disposed in the body of water and extends out of the body of water, a skirt and ballast section beneath the floating section, and an anchor section that secures the boom at a relatively fixed location, wherein at least one of the one or more booms has a boom monitoring section that includes a measurement component and a communication component;
   measuring data associated with the operation of at least one of the one or more booms with the measurement component; and
   transmitting a signal associated with the data to a command unit via the communication component.
2. The method of paragraph 1, comprising configuring the communication component in the at least one of the one or more booms based on the location of the boom and whether any other booms are positioned near the location.
3. The method of paragraphs 1 or 2, wherein deploying the one or more booms comprises programming the one or more booms to be able to communication with the command unit.
4. The method of any one of paragraphs 1 to 3, wherein deploying the one or more booms comprises programming the one or more booms to be able to communicate with another one or more booms.
5. The method of any one of paragraphs 1 to 4, wherein the signal is transmitted to the command unit at least every 10 seconds.
6. The method of any one of paragraphs 1 to 4, wherein the signal is transmitted to the command unit when a boom operation event occurs.
7. The method of any one of paragraphs 1 to 6, wherein the measuring data comprises obtaining the position of the one or more booms.
8. The method of any one of paragraphs 1 to 6, wherein the measuring data comprises obtaining an indication whether the floating section is in contact with hydrocarbons.
9. The method of any one of paragraphs 1 to 6, wherein the measuring data comprises obtaining an indication whether the integrity of the floating section is intact.
10. The method of any one of paragraphs 1 to 6, wherein the measuring data comprises obtaining an indication whether the floating section is submerges below a certain depth in the water.
11. The method of any one of paragraphs 1 to 6, wherein the measuring data comprises obtaining an indication whether the pressure within the floating section is below a threshold.
12. The method of any one of paragraphs 1 to 11, comprising displaying an indication of a boom operation event based from the transmitted signal.
13. The method of any one of paragraphs 1 to 12, comprising generating an audible notification to indicate a boom operation event based from the transmitted signal.
14. The method of any one of paragraphs 12 and 13, comprising deploying a response team to repair the one or more booms based upon one or more of the indication and audible notification.
15. The method of any one of paragraphs 1 to 14, comprising:
   measuring data associated with the operation of at least a second one of the one or more booms with a second measurement component; and
   transmitting a second signal associated with the data associated with the operation of at least the second one of the one or more booms to the command unit via a second communication component, wherein the at least the second one of the one or more booms has a second boom monitoring section that includes a second measurement component and a second communication component.
16. The method of any one of paragraphs 1 to 14, comprising:
   measuring data associated with the operation of at least a second one of the one or more booms with a second measurement component; and
   transmitting a second signal associated with the data associated with the operation of at least the second one of the one or more booms to the command unit via the communication component.
17. A boom monitoring system comprising:
   a command unit;
   a boom in communication with the command unit, wherein the boom includes:
      a floating section that is partially disposed in the body of water and extends out of the body of water,
      a skirt and ballast section beneath the floating section and
      an anchor section that secures the boom at a relatively fixed location; and
      a boom monitoring section that includes a measurement component and a communication component; wherein the measurement component measures data associated with the operation of the boom; and the communications component transmits a signal associated with the data to the command unit.
18. The system of paragraph 17, wherein the skirt and ballast section is configured to maintain proper boom orientation relative to the water surface.
19. The system of any one of paragraphs 17 to 18, wherein the boom further includes a power component that is configured to provide power to one or more of the measurement component and the communication component.
20. The system of paragraph 19, wherein the power component includes a battery and equipment configured to utilize one or more wind, waves, and/or solar to generate power for the boom.
21. The system of any one of paragraphs 17 to 20, wherein communication component is configured to transmit to the command unit via one or more of wireless communication hardware and satellite communication hardware.
22. The system of any one of paragraphs 17 to 21, wherein measurement component comprises a global positioning system (GPS) module and sensors that are configured to monitor the location of the boom.
23. The system of any one of paragraphs 17 to 22, wherein measurement component comprises a hydrocarbon sensing module and sensors that is configured to monitor the flotation section for contact with hydrocarbons.
24. The system of paragraph 23, wherein the hydrocarbon sensing module and sensors measure the electrical resistance at various locations along the length of the floating section
25. The system of any one of paragraphs 17 to 24, wherein measurement component comprises a pressure module and sensors that are configured to measure pressure along the floating section.
26. The system of any one of paragraphs 17 to 25, wherein measurement component comprises an air pressure module and sensors that are configured to monitor the pressure within the flotation section.
27. The system of any one of paragraphs 17 to 26, wherein measurement component comprises a boom integrity module and sensors configured to determine if the flotation or skirt section is damaged.
28. The system of any one of paragraphs 17 to 27, wherein the command unit is a computer system comprising:
   a processor;
   memory in communication with the processor; and
   a set of instructions stored on the memory and accessible by the processor, wherein the set of instructions, when executed, are configured to:
   receive a transmitted signal from the boom;
   determine whether the transmitted signal indicates that a boom operation event has occurred;
   provide one or more of a visual indication and audible notification associated with the boom operation event, if a boom operation event has occurred; and store the updated status in memory if a boom operation event has not occurred.
29. The system of paragraph 28, wherein the determination of whether the transmitted signal indicates that the boom operation event has occurred; comprises a set of instructions, when executed, configured to:
   compare current boom location to an initial boom location; and
   compare the difference between the locations with a threshold;
   if the difference is greater than the threshold, then indicate that a boom operation event has occurred; and
   if the difference is less than or equal to the threshold, then indicate that a boom operation event has not occurred.
30. The system of paragraph 28, wherein the determination of whether the transmitted signal indicates that the boom operation event has occurred; comprises a set of instructions, when executed, configured to:
   compare the measured resistance to a resistance range; and
   if the measured resistance is within the resistance range, then indicate that a boom operation event has not occurred; and
   if the measured resistance is outside the resistance range, then indicate that a boom operation event has occurred.
31. The system of paragraph 28, wherein the determination of whether the transmitted signal indicates that the boom operation event has occurred; comprises a set of instructions, when executed, configured to:
   compare the measured pressure to a pressure range of hydrocarbon resistance; and
   if the measured pressure is within the pressure range, then indicate that a boom operation event has not occurred; and
   if the measured pressure is outside the pressure range, then indicate that a boom operation event has occurred.
32. A boom monitoring system comprising:
   a second boom in communication with the command unit, wherein the second boom includes:
   a second floating section that is partially disposed in the body of water and extends out of the body of water,
   a second skirt and ballast section beneath the second floating section and
   a second anchor section that secures the second boom at a relatively fixed location; and
   a second boom monitoring section that includes a second measurement component and a second communication component; wherein the second measurement component measures data associated with the operation of the second boom; and the second communications component transmits a signal associated with the data to the command unit.

It should be understood that the preceding is merely a detailed description of specific embodiments of the invention and that numerous changes, modifications, and alternatives to the disclosed embodiments can be made in accordance with the disclosure here without departing from the scope of the invention. The preceding description, therefore, is not meant to limit the scope of the invention. Rather, the scope of the invention is to be determined only by the appended claims and their equivalents. It is also contemplated that structures and features embodied in the present examples can be altered, rearranged, substituted, deleted, duplicated, combined, or added to each other. The articles “the”, “a” and “an” are not necessarily limited to mean only one, but rather are inclusive and open ended so as to include, optionally, multiple such elements.

1. A method for managing an oil release with one or more booms, comprising:
deploying one or more booms to a location in a body of water, wherein each of the booms has a floating section that is partially disposed in the body of water and extends out of the body of water, a skirt and ballast section beneath the floating section, and an anchor section that secures the boom at a relatively fixed location, wherein at least one of the one or more booms has a boom monitoring section that includes a measurement component and a communication component;
measuring data associated with the operation of at least one of the one or more booms with the measurement component; and
transmitting a signal associated with the data to a command unit via the communication component.

2. The method of claim 1, comprising configuring the communication component in the at least one of the one or more booms based on the location of the boom and whether any other booms are positioned near the location.

3. The method of claim 1, wherein deploying the one or more booms comprises programming the one or more booms to be able to communication with the command unit.

4. The method of claim 1, wherein deploying the one or more booms comprises programming the one or more booms to be able to communicate with another one or more booms.

5. The method of claim 1, wherein the signal is transmitted to the command unit at least every 10 seconds.

6. The method of claim 1, wherein the signal is transmitted to the command unit when a boom operation event occurs.

7. The method of claim 1, wherein the measuring data comprises obtaining the position of the one or more booms.

8. The method of claim 1, wherein the measuring data comprises obtaining an indication whether the floating section is in contact with hydrocarbons.

9. The method of claim 1, wherein the measuring data comprises obtaining an indication whether the integrity of the floating section is intact.

10. The method of claim 1, wherein the measuring data comprises obtaining an indication whether the floating section is submerges below a certain depth in the water.

11. The method of claim 1, wherein the measuring data comprises obtaining an indication whether the pressure within the floating section is below a threshold.

12. The method of claim 1, comprising displaying an indication of a boom operation event based from the transmitted signal.

13. The method of claim 1, comprising generating an audible notification to indicate a boom operation event based from the transmitted signal.

14. The method of claim 12, comprising deploying a response team to repair the one or more booms based upon one or more of the indication and audible notification.

15. The method of claim 1, comprising:
measuring data associated with the operation of at least a second one of the one or more booms with a second measurement component; and
transmitting a second signal associated with the data associated with the operation of at least the second one of the one or more booms to the command unit via a second communication component, wherein the at least the second one of the one or more booms has a second boom monitoring section that includes a second measurement component and a second communication component.

16. The method of claim 1, comprising:
measuring data associated with the operation of at least a second one of the one or more booms with a second measurement component; and
transmitting a second signal associated with the data associated with the operation of at least the second one of the one or more booms to the command unit via the communication component.

17. A boom monitoring system comprising:
a command unit;
a boom in communication with the command unit, wherein the boom includes:
a floating section that is partially disposed in the body of water and extends out of the body of water,
a skirt and ballast section beneath the floating section and
an anchor section that secures the boom at a relatively fixed location; and
a boom monitoring section that includes a measurement component and a communication component; wherein the measurement component measures data associated with the operation of the boom; and the communications component transmits a signal associated with the data to the command unit.

18. The system of claim 17, wherein the skirt and ballast section is configured to maintain proper boom orientation relative to the water surface.

19. The system of claim 17, wherein the boom further includes a power component that is configured to provide power to one or more of the measurement component and the communication component.

20. The system of claim 19, wherein the power component includes a battery and equipment configured to utilize one or more wind, waves, and/or solar to generate power for the boom.

21. The system of claim 17, wherein communication component is configured to transmit to the command unit via one or more of wireless communication hardware and satellite communication hardware.

22. The system of claim 17, wherein measurement component comprises a global positioning system (GPS) module and sensors that are configured to monitor the location of the boom.

23. The system of claim 17, wherein measurement component comprises a hydrocarbon sensing module and sensors that is configured to monitor the flotation section for contact with hydrocarbons.

24. The system of claim 23, wherein the hydrocarbon sensing module and sensors measure the electrical resistance at various locations along the length of the floating section

25. The system of claim 17, wherein measurement component comprises a pressure module and sensors that are configured to measure pressure along the floating section.

26. The system of claim 17, wherein measurement component comprises an air pressure module and sensors that are configured to monitor the pressure within the flotation section.

27. The system of claim 17, wherein measurement component comprises a boom integrity module and sensors configured to determine if the flotation or skirt section is damaged.

28. The system of claim 17, wherein the command unit is a computer system comprising:
a processor;
memory in communication with the processor; and
a set of instructions stored on the memory and accessible by the processor, wherein the set of instructions, when executed, are configured to:
receive a transmitted signal from the boom;
determine whether the transmitted signal indicates that a boom operation event has occurred;
provide one or more of a visual indication and audible notification associated with the boom operation event, if a boom operation event has occurred; and
store the updated status in memory if a boom operation event has not occurred.

29. The system of claim 28, wherein the determination of whether the transmitted signal indicates that the boom operation event has occurred; comprises a set of instructions, when executed, configured to:
compare current boom location to an initial boom location; and
compare the difference between the locations with a threshold;
if the difference is greater than the threshold, then indicate that a boom operation event has occurred; and
if the difference is less than or equal to the threshold, then indicate that a boom operation event has not occurred.

30. The system of claim 28, wherein the determination of whether the transmitted signal indicates that the boom operation event has occurred; comprises a set of instructions, when executed, configured to:
compare the measured resistance to a resistance range; and
if the measured resistance is within the resistance range, then indicate that a boom operation event has not occurred; and
if the measured resistance is outside the resistance range, then indicate that a boom operation event has occurred.

31. The system of claim 28, wherein the determination of whether the transmitted signal indicates that the boom operation event has occurred; comprises a set of instructions, when executed, configured to:
compare the measured pressure to a pressure range of hydrocarbon resistance; and
if the measured pressure is within the pressure range, then indicate that a boom operation event has not occurred; and
if the measured pressure is outside the pressure range, then indicate that a boom operation event has occurred.

32. The system of claim 17, comprising:
a second boom in communication with the command unit, wherein the second boom includes:
a second floating section that is partially disposed in the body of water and extends out of the body of water,
a second skirt and ballast section beneath the second floating section and
a second anchor section that secures the second boom at a relatively fixed location; and
a second boom monitoring section that includes a second measurement component and a second communication component; wherein the second measurement component measures data associated with the operation of the second boom; and the second communications component transmits a signal associated with the data to the command unit.
